(19) United States
(12) Patent Application Publication
(10) Pub. No.: US 2014/0196100 A1
(43) Pub. Date: Jul. 10, 2014

(54) ELECTRONIC DEVICE FOR PROVIDING MEDIA RECOMMENDATIONS AND A METHOD THEREIN

(71) Applicants: Petter Alexandersson, Bjarred (SE); Jenny Fredriksson, San Diego, CA (US)

(72) Inventors: Petter Alexandersson, Bjarred (SE); Jenny Fredriksson, San Diego, CA (US)

(73) Assignee: SONY MOBILE COMMUNICATIONS AB, Lund (SE)

(21) Appl. No.: 13/817,074

(22) PCT Filed: Feb. 24, 2012
(86) PCT No.: PCT/EP2012/053156

§ 371 Date: Feb. 14, 2013

(51) Int. Cl. H04N 21/25

(52) U.S. Cl. CPC H04N 21/251
USPC 725/109

(57) ABSTRACT

An object of the present invention is to provide a mechanism in a first electronic device (101) to provide media recommendations to a user of a second electronic device (102) connected to a communications network (100).

Embodiments relate to a first electronic device (101) for providing media recommendations and a method therein. The method comprises analysing (201) media content shared by at least one second electronic device (102) over the communications network (100) to determine at least one media preference of the user of the at least one second electronic device (102) and transmitting (204) a signal relating to a recommended media content to the at least one second electronic device (102) in dependence of the determined at least one media preference.

### TECHNICAL FIELD

Embodiments herein relate to an electronic device, and a method therein. In particular, embodiments relate to the providing of media recommendations over a communications network.

### BACKGROUND

During the last years, social media has spread quickly. Social media, such as Facebook™, LinkedIn™, Foursquare™ and Twitter™, enables its users to stay connected to each other. Social media is also an excellent and efficient way of discovering media such as musics, videos, photos, and games by getting recommendations from friends. The discovered media may come from online content providers like Spotify™, Youtube™, SoundCloud™, Vimeo™ or Flicker™.

Several ways of using social media have been observed.

A first way is about emphasizing the relevance of a specific media item and trying to determine why this specific media is relevant to us. Today we are continuously exposed to more media than we can consume, whereby we constantly must determine whether or not the current media is relevant for us. A problem with this is that it takes a lot of resources to determine if the current media is relevant for us.

A second way is about pioneering i.e. to be the first of your friends to discover new media, such as a good song/video/game, and to recommend it to friends or other persons. It's wanted to be the first person to recommend the newly discovered media. It's aiso wanted not to recommend the media to persons who are not interested in the new media. A problem with this is that the user who wants to recommends the newly discovered media to another person, not always know if the other person is interested in the media to be recommended. Studies show that spam is a big problem in social networks, and people who share lots of recommendations that are not considered relevant for the receivers can be removed from the receiver's friend list to avoid spam. This problem is increasing since the friend list gets longer and longer. Today it is not unusual to have a list of 1000 friends on Facebook™. The incitement to provide a solution for creating more personal and relevant recommendation is therefore growing.

### SUMMARY

It is therefore an object of embodiments herein to provide a way of improving the user experience when recommending media content over the communications network.

in accordance with a first aspect of an embodiment, a method in a first electronic device is provided. The first electronic device is connectable to a communications network. The first electronic device analyses shared media content shared by at least one second electronic device over the communications network to determine at least one media preference of the user of the at least one second electronic device. The first electronic device further transmits a signal relating to recommended media content to the at least one second electronic device in dependence of the determined at least one media preference.

In accordance with a second aspect of an embodiment, a first electronic device is provided. The first electronic device is connectable to a communications network. The first electronic device comprises a first analysing unit adapted to analyse shared media content shared by at least one second electronic device over the communications network to determine at least one media preference of the user of the at least one second electronic device. The first electronic device further comprises a transmitting unit adapted to transmit a signal relating to a recommended media content to the at least one second electronic device in dependence of the determined at least one media preference.

Since shared media content is analysed to determine at least one media preference and since media content is recommended in dependence of the determined at least one media preference, media content is recommended in a smart and efficient way. This results in an improved user experience when recommending media content over the communications network. The embodiments described herein also follow the “frictionless recommending trend” i.e. everything is automatically recommended.

An advantage with embodiments herein is that the user of the second electronic device, receiving the media recommendation experiences that the media recommendations are filtered. This means that there is a higher precision and less noise in the recommendations.

A further advantage with embodiments herein is that the recommendations are personal and more relevant and that spam is reduced.

A further advantage with embodiments herein is that the user of the first electronic device can be surer of sending relevant recommendations to his friends.

### BRIEF DESCRIPTION OF THE DRAWINGS

Examples of embodiments herein are described in more detail with reference to attached drawings in which:

FIG. 1 is a schematic block illustrating a communications network;

FIG. 2 is a flowchart depicting embodiments of a method in a first electronic device; and

FIG. 3 is a schematic block illustrating a first electronic device according to embodiments herein.

### DEFINITIONS

When used herein the expression “shared media content” should be understood to be the media content shared by a second electronic device.

When used herein the expression “suggested media content” should be understood to be the media content suggested by the first electronic device to the user of the first electronic device. The user may then determine if the suggested media content should be recommended to a user of the second electronic device.

When used herein the expression “recommended media content” should be understood to be the media content recommended to the user of the second electronic device by the user of the first electronic device.

When used herein the expression “discovered media content” should be understood to be a new media content discovered by the first electronic device. For example, “discovered media content” may be “recommended media content” which has been recommended by a user of another first electronic device. However “discovered media content” may also be media found/bought on the internet or heard on the radio, just to mention some examples.

### DETAILED DESCRIPTION

Embodiments will be exemplified in a non-limiting description.

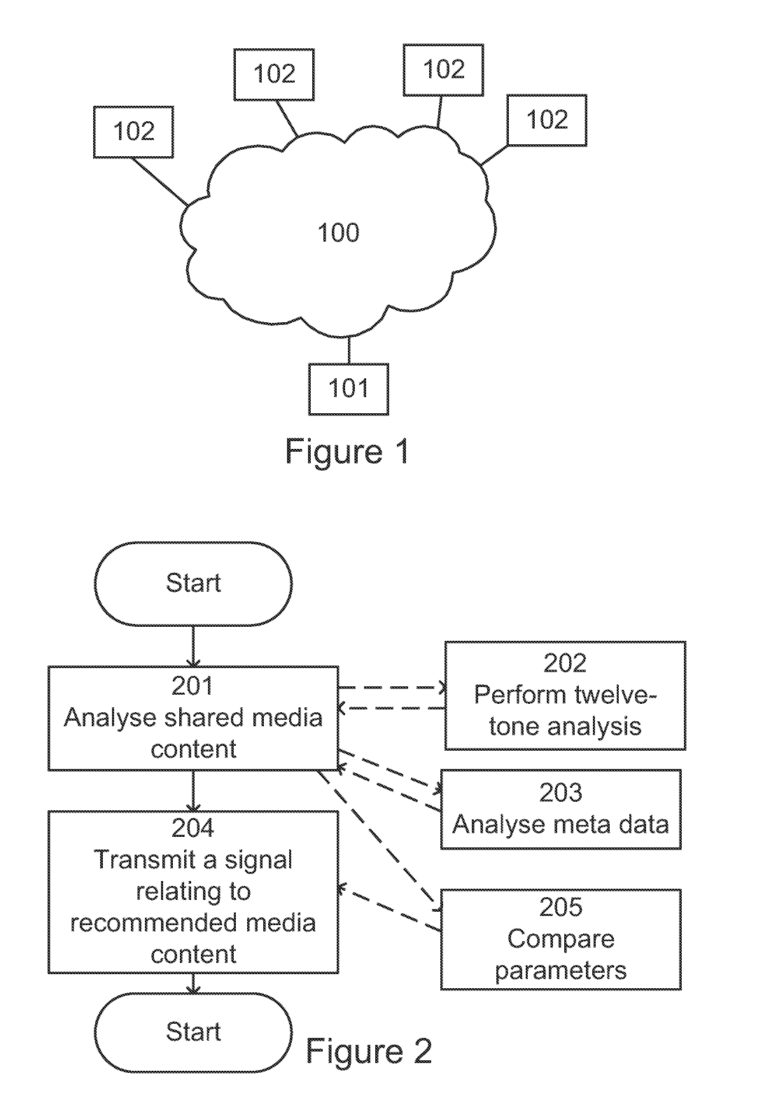

FIG. 1 depicts a communications network 100 such as a social media network in which embodiments herein may be implemented. A first electronic device 101 is connectable to the communications network 100 via a cable or any kind of wireless interface. To the communications network 100 is also at least one second electronic device 102 connected by any means of a cable or a wireless interface. The first electronic device 101 and the second electronic device 102 may be a computer, a mobile phone, a tablet or any other connectable device. Through the communications network 100 the user of the first electronic device 101 is able to recommend media content to a user of the second electronic device 102.

In some embodiments the first 101 and the second electronic device 102 are similar devices or devices configured to function in a similar way. Thus, the second electronic device 102 may recommend media content to a user of the first electronic device 101. However for the sake of clarity we will herein only describe the case when the first electronic device 101 recommend media content to the user of the second electronic device 102.

Embodiments of a method in the first electronic device 101 for providing media recommendations will now be described with reference to the flowchart depicted in FIG. 2. The method comprises the following actions, which actions may be carried out in another suitable order than described below. Actions may also be combined.

Embodiments herein comprise a method in the first electronic device 101 for providing media recommendations. The first electronic device 101 is connectable to the communications network 100.

Action 201

The first electronic device 101 analyses shared media content.

The first electronic device 101 may analyse shared media content shared by at least one second electronic device 102 over the communications network 100 to determine at least one media preference of the user of the at least one second electronic device 102. The first electronic device 101 may analyse the shared media content continuously or on scheduled intervals.

Further, the first electronic device 101 may determine several media preferences for each user of the at least one second electronic device 102.

Media content may be shared by the at least one second electronic device 102 connected to the communications network 100. Media content may be shared to other devices such as the second electronic device 102 and the first electronic device 101. The second electronic device 102 may share the media content either actively or passively. Active sharing may be that the second electronic device 102 actively shares media content to the user of the first electronic device 101 and/or to a user of another second electronic device 102. Passive sharing may be more related to consumption of the second electronic device 102. Passively shared media content may e.g. be information about which media, such as songs and biog posts, the second electronic device 102 consumes the most.

The shared media content may comprise a music file, a video clip, a picture, an application software, a game, a recipe, a website, a blog post and/or a news article. This is examples of different media types.

The media preference may be any preference of the user of the second electronic device 102 relating to the shared media content. Below the media preference will be exemplified. In the context that the shared media content is a music file, the media preference may e.g. be a genre, the performer or a band playing a song. In the context that shared media content is a blog post or a news article, the media preference may e.g. be the origin of the shared media or any information relating to a written information in the shared media content. The written information may relate to a topic or a keyword, in the context that the shared media content is a movie file, the media preference may e.g. be a genre, information about an actor or a producer. Other examples of media preference may be any type of metadata; e.g. artist, album, country, year, record label, genre, track length, beats per minute, instrument used and mood.

The media preference may further comprise a classification of the shared media content. The media preference of the shared media content from the second electronic device 102 may be classified into one or more classes. The classes may comprise information that is common for several types of shared media content. An example of a class may e.g. be dogs. Dogs may be a media preference if shared media content containing dogs in several types of media, such as pictures, music files or news articles. This is sometimes referred to as cross reference comparison. Cross media comparison expands the possibility to create new and personal recommendations.

The media preference may comprise a genre of the shared media content. The genre of the shared media content may depend on which type the shared media content relate to. If the shared media content relates to music, genres of the shared media content may e.g. be pop music, classical music.

Action 202

In some embodiments, the shared media content comprises a music file. The analyse of the shared media content in relation to action 201 may further comprise the action of performing a twelve-tone analysis of the music file. By performing a twelve tone analysis the first electronic device 101 may obtain a set of metadata. The twelve-tone analysis is a well-known method to analyse content of a music file. The output of the twelve-tone analysis may be metadata with information about the shared media content. Examples of the information about the shared media content may be artist, album, country, year, record label, genre, track length, beats per minute, instrument used and mood.

Action 203

The first electronic device 101 may analyse metadata relating to the shared media content. The metadata may further comprise information about the shared media content. In some embodiments the metadata is a text-file connected to the shared media content with information about the shared media content. The metadata connected to the shared media content may further comprise information about where and when the shared media content was recorded or produced. The metadata may further comprise information regarding artist, album, country, year, record label. Just to mention some examples.

The suggested media content is presented to the user of the first electronic device 101. The user of the first electronic device 101 may now decide if he/she wants to recommend the suggested media content to the user of the second electronic device 102. If he/she want to recommend the media content this will be called recommended media content, in another embodiment this is done automatically.

Action 204

The first electronic device 101 transmits a signal relating to a recommended media content to the at least one second electronic device 102, The signal is transmitted in dependence of the at least one media preference. By transmitting the signal, media content may be recommended to the user of the second electronic device 102.

Discovered media content may be recommended to the user of the second electronic device 102 in dependence of the determined at least one media preference. When the user of the first electronic device 101 discovers new media content, he/she may want to recommend it to one or more users of one or more second electronic devices 102 if they are interested in the discovered media content. Discovered media content may be any media content that is available in the first electronic device 101. The discovered media content may e.g. be another media recommendation, media found/bought on the internet or heard on the radio, just to mention some examples, in order to know who to suggest the discovered media to, the first electronic device 101 analyses the discovered media content and compare it with the at least one media preference of the at least one second electronic device 102. The analyse of the discovered media may be performed in the same way as the analyse described in relation to actions 201-203. If it is determined that the discovered media content may be interesting for the user of the at least one second electronic device 102, the first electronic device 101 suggests that the user of the first electronic device 101 may recommend the discovered media content the at least one second electronic device 102. For example, when the user of the first electronic device 101 is listening to a newly bought song, an option to recommend it to the second electronic device 102 in the communications network 100 may be presented in a user interface. The media content suggested to the at least one second electronic device 102 will below be called suggested media content.

The signal relating to the recommended media content may be sent to the user of the second electronic device 102 may e.g. be an SMS with a link to the suggested media content, or a message sent via any social media.

The suggested media content and the recommended media content may comprise a music file, a video clip, a picture, an application software, a blog and/or a news article, just to mention some examples.

Action 205

In some embodiments, the first electronic device 101 compares parameters. One way to determine if the discovered media content should be suggested to the user of the first electronic device 101 as to be recommended to the user of the second electronic device 102 may be to compare a parameter of the shared media content with a parameter of the discovered media content.

The parameters to be compared may relate to the genre or the classification.

One way to compare the parameters is to look for overlaps of the metadata in the shared media content from the at least one second electronic device 102 and the metadata of the discovered media content. One example will be described below. If the first electronic device 101 has analysed the shared media content and has come to the conclusion that the media preference relating to music of the second electronic device 102 is a certain musician in a certain genre. If the first electronic device 101 has identified that the discovered media content comprises a new song from the same musician in the same genre, the discovered media content may be suggested to the user of the first electronic device 101.

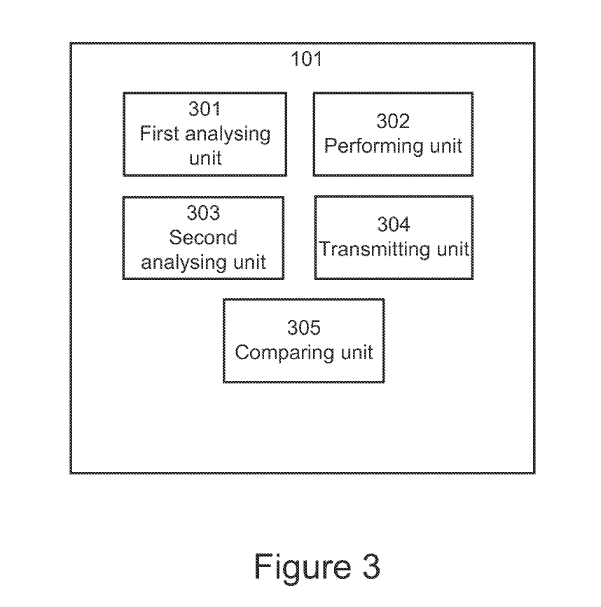

To perform the method actions in the first electronic device 101 described above for providing media recommendations, the first electronic device 101 comprises the following arrangement depicted in FIG. 3.

The first electronic device 101 is adapted to transmit a signal relating to a media recommendation to at least one second electronic device 102. This may e.g. be performed through a user interface of the first electronic device 101. The first electronic device 101 and the second electronic device 102 are connectable to a communications network 100.

The first electronic device 101 comprises a first analysing unit 301 adapted to analyse 201 shared media content shared by at least one second electronic device 102 over the communications network 100 to determine at least one media preference of the user of the at least one second electronic device 102. The first analysing unit 301 is further adapted to implement ail the features described in relation to action 201 above.

The first electronic device 101 further comprises transmitting unit 394 adapted to transmit 204 a signal relating to a recommended media content to the at least one second electronic device 102 in dependence of the determined at least one media preference. The transmitting unit 304 is further adapted to implement all the features described in relation to action 204 above.

The shared media content and/or the recommended media content in the first electronic device 101 may comprises a music file, a video clip, a picture, an application software, a biog and/or a news article.

The first electronic device 101 may further comprise a performing unit 302 adapted to perform a twelve-tone analysis of the music file whereby a set of metadata is obtained. The twelve tone analysis is a well-known technology from Sony™ to analyse music files. The performing unit 302 is further adapted to implement ail the features described in relation to action 202 above.

The first electronic device 101 may further comprise a second analysing unit 303 adapted to analyse metadata relating to the shared media content, wherein the metadata comprises information about the shared media content. The second analysing unit 303 is further adapted to implement ail the features described in relation to action 203 above.

The media preference of the at least one second electronic device 102 may comprise a classification of the shared media content.

The media preference of the at least one second electronic device 102 may comprise a genre of the shared media content.

The first electronic device 101 may further comprise a comparing unit 305 adapted to compare a parameter of the shared media content with a parameter of the discovered media content. The comparing unit 305 is further adapted to implement all the features described in relation to action 205 above.

Embodiments herein do also refer to a computer program product. The computer program product is loadable into a memory of a computerized device and comprises software code portions adapted for realizing one or more of the features of the first electronic device 101 and/or performing one or more actions of the method described above.

Those skilled in the art will appreciate that the first analysing unit 301, the performing unit 302, the second analysing unit 303, the transmitting unit 304 and the comparing unit 305 described above may refer to a combination of analog and digital circuits, and/or one or more processors configured with software and/or firmware, e.g. stored in a memory, that when executed by the one or more processors are able to perform the embodiments described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above-described preferred embodiments. Various alternatives, modifications and equivalents may be used. Therefore, the embodiments should not be taken as limiting the scope of the invention, which is defined by the appending claims.

1. A method in an first electronic device (101) for providing media recommendations over a communications network (100), wherein the first electronic device (101) is connectable to the communications network (100), and wherein the method comprises:
analysing (201) shared media content shared by at least one second electronic device (102) over the communications network (100) to determine at least one media preference of the user of the at least one second electronic device (102); and
transmitting (204) a signal relating to a recommended media content to the at least one second electronic device (102) in dependence of the determined at least one media preference, whereby the recommended media content can be recommended to the user of the second electronic device (102).

2. The method according to claim 1, wherein the shared media content and/or the recommended media content may comprises a music file, a video clip, a picture, an application software, a blog and/or a news article.

3. The method according to claim 2, wherein the shared media content comprises a music file, and wherein the analysing (201) of the shared media content further comprises:
performing (202) a twelve-tone analysis of the music file, whereby a set of metadata is obtained.

4. The method according to claim 1, wherein the analysing (201) of the shared media content further comprises:
analysing (203) metadata relating to the shared media content, wherein the metadata comprises information about the shared media content.

5. The method according to claim 1, wherein the at least one media preference comprises a classification of the shared media content.

6. The method according to claim 1, wherein the at least one media preference comprises a genre of the shared media content.

7. The method according to claim 1, wherein the method further comprises:
comparing (205) a parameter of the shared media content with a parameter of a discovered media content.

8. An first electronic device (101) for providing media recommendations over a communications network (100), wherein the first electronic device (101) is connectable to the communications network (100), and wherein the first electronic device (101) comprises:
a first analysing unit (301) adapted to analyse shared media content shared by at least one second electronic device (102) over the communications network (100) to determine at least one media preference of the user of the at least one second electronic device (102); and
a transmitting unit (304) adapted to transmit a signal relating to a recommended media content to the at least one second electronic device (102) in dependence of the determined at least one media preference, whereby the recommended media content can be recommended to the user of the second electronic device (102).

9. The first electronic device (101) according to claim 8, wherein the shared media content and/or the recommended media content may comprise a music file, a video clip, a picture, an application software, a biog and/or a news article.

10. The first electronic device (101) according to claim 9, wherein the shared media content comprises a music file, and wherein the first electronic device (101) further comprises:
a performing unit (302) adapted to perform a twelve-tone analysis of the music file, whereby a set of metadata is obtained.

11. The first electronic device (101) according to claim 8, wherein the first electronic device (101) further comprises:
a second analysing unit (303) adapted to analyse metadata relating to the shared media content, wherein the metadata comprises information about the shared media content.

12. The first electronic device (101) according to claim 8, wherein the at least one media preference comprises a classification of the shared media content.

13. The first electronic device (101) according to claim 8, wherein the at least one media preference comprises a genre of the shared media content.

14. The first electronic device (101) according to claim 8, wherein the first electronic device (101) further comprises:
a comparing unit (305) adapted to compare (205) a parameter of the shared media content with a parameter of a discovered media content.

15. A computer program product loadable into a memory of a computerized device and comprising software code portions adapted for performing one or more actions of claim 1 and/or realizing one or more of the features of claim 8.
